(19) United States
(12) Patent Application Publication
(10) Pub. No.: US 2004/0164509 A1
(43) Pub. Date: Aug. 26, 2004

(54) Wheelbarrow

(76) Inventors: Jeffery D. Campbell, Fresno, CA (US); Rick D. Fox, Santa Cruz, CA (US)

Correspondence Address: JEFFREY HALL, 212 CLINTON ST, SANTA CRUZ, CA, 95062, US

(21) Appl. No.: 10/373,220

(22) Filed: Feb. 24, 2003

(51) Int. Cl. B62B 1/00

(52) U.S. Cl. 280/47.31

(57) ABSTRACT

A wheelbarrow (10) comprising a frame (18A, 18B) having a pair of handles (2A, 2B) with each handle having a proximal and a distal end and a pair of downwardly depending support elements. A first wheel (7) is secured to the distal ends of the pair of handles (2A, 2B) by a frame element and a rear set of wheels (20A, 20B) is secured to the proximal ends of the pair of handles (2A, 2B) by a frame element (22). The first wheel includes an internal brake drum and internal brake shoes (9) secured to a brake cable with a cam and to a hand operated reversing brake lever. A load bucket (1) is mounted to the frame and is slideable moveable on the frame.

### CROSS REFERENCE TO RELATED APPLICATIONS

This application is related to and claims priority from U.S. patent application Ser. No. 09/094,441, filed Jun. 10, 1998.

### BACKGROUND OF THE INVENTION

### 37 C.F.R. 1.77(a)(7)

1. Field of Invention

This invention relates to transporting and carrying apparatuses such wheelbarrows, and more particularly to wheelbarrows which are equipped with a rear set of wheels and a hand operated braking mechanism.

2. Description of Related Art

The usefulness of carrying apparatuses such as wheelbarrows are well known to those involved in construction, farming, gardening, and other uses where objects, loads, people, or the like are moved and transported from one place to another.

Heretofore, attempts have been made to power or motorize various tools and carriers such as carts, tractors, golf carts, wheelbarrows, and the like by using gasoline powered engines in order to propel the device. Other devices have used various braking systems and manual power.

The present invention is a wheelbarrow having a rear set of wheels secured to the proximal ends of the wheelbarrow handles, and a hand operated braking mechanism for ease of operation and safety.

Accordingly, it is the primary object of this invention to provide a wheelbarrow which is lightweight, strong, balanced, and efficient at carrying and transporting a wide range of load sizes and weights and which is equipped with a rear set of wheels for balance and ease of use. The wheelbarrow of the present invention has high performance capability and is balanced and safe to use with small, medium or large loads. The wheelbarrow of the present invention also includes a hand operated braking system for control and safety.

Additional objects and advantages of the invention will be set forth in the description which follows, and in part will be obvious from the description, or may be learned by practice of the invention. The objects and advantages of the invention may be realized and obtained by means of the instrumentality's and combinations particularly pointed out in the appended claims

### BRIEF SUMMARY OF THE INVENTION

### 37 C.F.R. 1.77(a)(8)

To achieve the foregoing objects, and in accordance with the purpose of the invention as embodied and broadly described herein, a wheelbarrow is provided comprising a frame having a pair of handles with each handle having a proximal and a distal end and a pair of downwardly depending support elements. A first wheel is secured to the distal ends of the pair of handles and a rear set of wheels is secured to the proximal ends of the pair of handles. The first wheel includes an internal brake drum and internal brake shores operably linked to a brake cable with cam operated tension control means and a hand operated brake lever. A load bucket is mounted to the frame and includes a dumping mechanism and a handle.

The wheelbarrow of the present invention is lightweight, balanced, efficient, and highly effective at allowing a user to transport loads of all sizes with great maneuverability, balance, and control. The wheelbarrow of the present invention allows a user to transport loads with ordinarily could not be easily or efficiently transported by a conventional wheelbarrow, thereby providing a highly efficient and safe transport means.

### BRIEF DESCRIPTION OF THE DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 is a left side elevational view of a wheelbarrow, according to the invention.

FIG. 2 is a right side elevational view of such a wheelbarrow, according to the invention.

FIG. 3 is a top view of such wheelbarrow with the load bucket detached, according to the invention.

FIG. 4 is a top view of the load bucket of such wheelbarrow, according to the invention.

### DETAILED DESCRIPTION OF THE INVENTION

### 37 C.F.R. 1.77(a)(10)

Reference will now be made in detail to the present preferred embodiments of the invention as illustrated in the accompanying drawings.

In accordance with the present invention, there is provided in a preferred embodiment of the invention, a wheelbarrow comprising a frame having a pair of handles with each handle having a proximal and a distal end and a pair of downwardly depending support elements. A first wheel is secured to the distal ends of the pair of handles by frame elements and a rear set of wheels is secured to the proximal ends of the pair of handles by a frame element. The first wheel includes an internal brake drum and internal brake shores linked to a cam activated cable and hand operated brake lever. A load bucket is mounted to the frame for transporting and carrying objects or particulates.

In accordance with the present invention, there is also provided an improved wheelbarrow of the type in which a frame is secured to a pair of handles each handle having a proximal and a distal end thereto and a pair of downwardly depending support elements. A first wheel is secured to the distal ends of the pair of handles. A load bucket is secured to the frame. The improvement comprises a rear set of wheels secured to the proximal ends of the pair of handles by a frame element and a first wheel with an internal brake drum and internal brake shoes linked to a cam actuated brake cable and hand operated brake lever.

In FIG. 1, the wheelbarrow 10, is shown according to a preferred embodiment of the invention with frame elements 18A and 18B preferably with end caps 13, and is secured to upright frame elements 5A, 5B, 5C, and 5D by welding or mechanical fastening means such as bolts, screws, nuts, and the like. Frame braces 16A and 16B downwardly depend and may be used for additional support and stability. The frame is secured to a pair of handles 2A and 2B, each having a proximal and a distal end, and which are preferably provided with handle grips 3A and 3B. Handles 2A and 2B may be configured to be removable from the frame if desired.

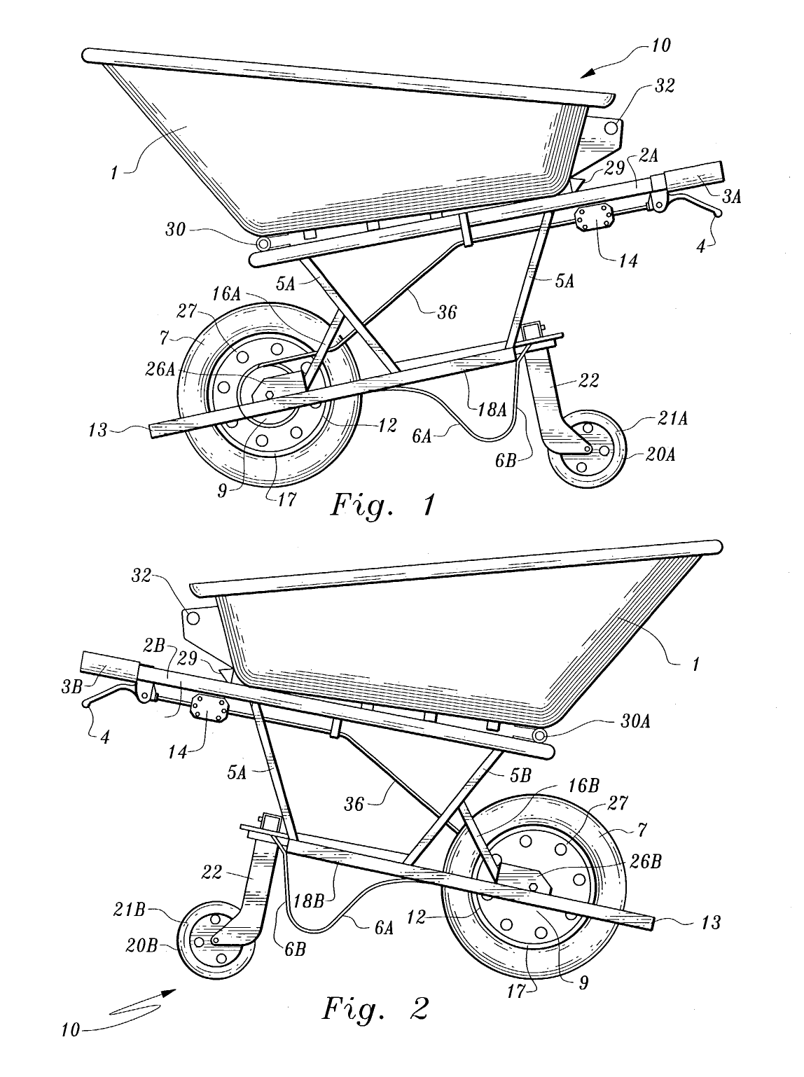

As seen in FIGS. 1 and 2, a load bucket 1, which is preferably composed of polyurethane or other durable and resilient material is secured to handles 2A and 2B. Bucket 1, may be a load bucket as shown, or in alternative embodiments, be a flat-bed type load bucket or carrier, or otherwise configured as desired. Fastening means such as bolts, nuts, and washers 24A and 24B are used to secured bucket 1, to the frame.

A first wheel 7, may be provided in various sizes is secured to the distal ends of handles 2A and 2B by frame tubing 18A and 18B and upright supports 5B and 5C, seen in FIGS. 1, 2 and 3. Wheel 7, may be provided with extension bearing hubs 17, as shown. Wheel 7, is linked by an axle housed in axle housing 26A and 26B to the sprocket wheel. Wheel 7, has an internal brake drum and internal brake shoes 9 operably linked to brake cable 36, and brake lever 4 with cam 14, for tension control of cable 36. The brake and brake lever are preferably configured as a reversing brake lever. When brake lever 4 is depressed this allows motion of motorized wheelbarrow 10. When brake lever 4 is released, the internal brake drum and brake shoes 9 are engaged preventing movement. Axle housing 26A and 26B are secured to the axle by an axle bolt 11, preferably a hex-head axle bolt with nylon locknut.

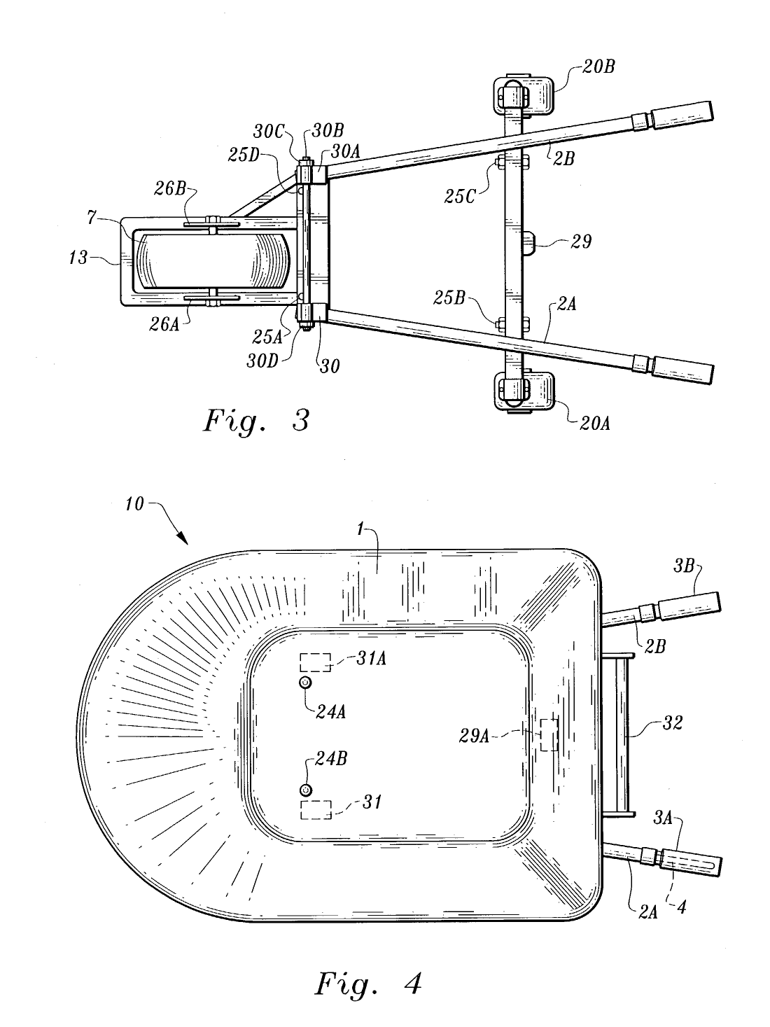

Best seen in FIGS. 1 and 3, a rear set of wheels 20A and 20B are preferably 6 inch castor wheels with ball bearings and a swivel flange and are preferably provided with tires 21A and 21B, however, in alternative embodiments different sizes and type wheels and tires may be provided as desired. Wheels 20A and 20B are detachable from the frame and are preferably mounted to removable tubing frame 22 comprising tubing frame elements, pins and snap rings. In FIG. 3, 25A, 25B, 25C and 25D are apertures for securing fastening means such as angle iron mountings, bolts, or the like for securing load bucket 1 to the frame.

Referring now to FIG. 4, load bucket 1 is shown and is preferably composed of polyethylene but may be otherwise composed. Load bucket 1 may be configured as shown or may be provided as a flat-bed type carrier, or other shapes and sizes depending upon the application. Load bucket 1 is preferably secured to the frame using a pair of metal hinge brackets 30 and 30A which mount to the frame by welding a rod 30B to the load bucket at a pair of bucket perches 31 and 31A. Bucket perches 31 and 31A are preferably polyethylene perches having a metal sleeve into which rod 30B attaches to metal hinge brackets 30 and 30A. Locking collars 30C and 30D secure rod 30B to bucket perches 31 and 31A. A handle strap mount 29A may be provided on load bucket 1 for frame latch 29. A bar 32 is shown in FIG. 4 to facilitate manually dumping or unloading a load carried in load bucket 1 may also be provided. Bar 32 is preferably secured to load bucket 1 with bolts, screws, rivets or other mechanical fastening means.

Additional advantages and modification will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

What is claimed:

1. A wheelbarrow, comprising:
a frame;
a pair of handles secured to said frame each handle having a proximal and a distal end thereto and a pair of downwardly depending support elements;
a first wheel secured to the distal ends of the pair of handles by frame elements;
a rear set of wheels secured to the proximal ends of the pair of handles by frame elements;
an internal brake drum and internal brake shoes operably mounted in said first wheel;
a brake cable with a cam actuated tension control mechanism operably linked to said internal brake drum and brake shoes; and
a load bucket secured to said frame, said load bucket having means for unloading a load carried therein by slideably positioning said load bucket in relation to said frame.

2. The wheelbarrow of claim 1, wherein said internal brake drum is operably linked to a brake lever mounted on one of said pair of handles and to a reversing brake lever mounted on one of said pair of handles.

3. The wheelbarrow of claim 1, further including a pair of metal skids secured to said frame.

4. The wheelbarrow of claim 1, wherein said rear set of wheels are detachably mounted to said frame.

5. The wheelbarrow of claim 1, wherein said load bucket is composed of polyethylene.

6. The wheelbarrow of claim 1, wherein said load bucket is a flat-bed configured load bucket.

7. An improved wheelbarrow of the type in which a frame is secured to a pair of handles each handle having a proximal and a distal end thereto and a pair of downwardly depending support elements, a first wheel is secured to the distal ends of the pair of handles by frame elements, and a load bucket is secured to the frame, wherein the improvement comprises:
a rear set of wheels secured to the proximal ends of the pair of handles by a frame element; and
an internal brake drum and internal brake shoes operably mounted in said first wheel and linked to a brake cable with a cam and secured to a brake lever.

8. The wheelbarrow of claim 7, wherein said internal brake drum is operably linked to a brake lever mounted on one of said pair of handles.

9. The wheelbarrow of claim 7, further including a pair of metal skids secured to said frame.

10. The wheelbarrow of claim 7, wherein said rear set of wheels are detachably mounted to said frame.

11. The wheelbarrow of claim 7, wherein said load bucket is composed of polyurethane.

12. The wheelbarrow of claim 11, wherein said load bucket is a flat-bed configured load bucket.
